(19) United States
(12) Patent Application Publication
(10) Pub. No.: US 2026/0352303 A1
(43) Pub. Date: Nov. 5, 2026

(54) OPTIMAL DEVICE SELECTION AND BEAMFORMING IN FEDERATED LEARNING WITH OVER-THE-AIR AGGREGATION

(71) Applicant: Telefonaktiebolaget LM Ericsson (publ), Stockholm (SE)

(72) Inventors: Faeze Moradi KALARDE, Toronto (CA); Ben LIANG, Whitby (CA); Min DONG, Whitby (CA); Yahia Eldemerdash AHMED, Kanata (CA); Ho TING CHENG, Stittsville (CA)

(21) Appl. No.: 19/119,261

(22) PCT Filed: Oct. 18, 2023
(86) PCT No.: PCT/IB2023/060536

§ 371 Date: Apr. 8, 2025

Related U.S. Application Data
(60) Provisional application No. 63/417,394, filed on Oct. 19, 2022.

(51) Int. Cl. H04B 7/06

(52) U.S. Cl. CPC H04B 7/0634

(57) ABSTRACT

A method and network node for optimal wireless device (WD) selection and beamforming in federated learning with over-the-air (OTA) aggregation are disclosed. According to one aspect, a method in a network node includes receiving an OTA aggregation of local gradients, each local gradient being transmitted by a different WD of a set of WDs on a same set of time and frequency resources. The method includes determining a set of transmit scalars based at least in part on an objective function of the aggregation of local gradients, each transmit scalar corresponding to at least one WD of the set of WDs. The method also includes transmitting the set of transmit scalars, each transmit scalar of the set of transmit scalars being transmitted to a corresponding WD of the set of WDs.

### FIELD

The present disclosure relates to wireless communications, and in particular, to optimal WD selection and beamforming in federated learning with over-the-air (OTA) aggregation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

In addition to these standards, the Institute of Electrical and Electronic Engineers (IEEE) has developed and continues to develop standards for other types of wireless communication networks, including Wireless Local Area Networks (WLANs), including Wireless Fidelity (Wi-Fi) networks. WLANS include wireless communication between access points (APs) and WDs.

Conventional machine learning (ML) systems use a powerful central server to support the vast amount of computation needed for training an ML model. Such systems need to collect data from all participating wireless devices and store them in the central server (network node). However, with the recent growth of mobile edge devices and their computational capability, training may be done in a distributed fashion by edge devices instead of the server.

In wireless communications, transferring data from the edge devices, such as wireless devices (WDs), to the server, such as a network node, threatens the privacy of each WD and requires precious resources such as bandwidth and energy. To address these challenges, a method called federated learning (FL) has been proposed to exploit the computational capability of edge WDs without requiring them to transmit their private training dataset. In FL, each WD computes the gradient of its local loss function and sends it to the network node. A global model is updated at the network node, based on the aggregation of local gradients received from the edge WDs. This procedure prevents edge WDs from sharing their dataset with the network node, and therefore, it reduces the communication overhead compared with centralized learning and it preserves the privacy of the edge WDs.

FL is an iterative algorithm. In each iteration, the local gradients are wirelessly transmitted to the network node. Since the number of WDs is usually large and there is a limited bandwidth, often the WDs cannot send their updates simultaneously by using conventional orthogonal multiple access methods. Therefore, to avoid communication latency, over-the-air computation has emerged. Over-the-air computation is an analog way of data transmission where the signals from different WDs are sent on the same radio resource and aggregated by the superposition property of a multiple access channel. Thus, the local gradients from the WDs are aggregated over the air and received by the network node in the form of a desired signal for updating the global model. Over-the-air computation reduces bandwidth usage and communication latency especially when the number of WDs increase.

Despite the above advantage of over-the-air computation method, it often suffers from low signal to noise ratio (SNR) when there exist WDs with substantially weaker channels compared with the other WDs. This is because the WDs with stronger channels need to lower their transmit power to align their signal amplitude with that of those signals from the WDs that have weak channels. Therefore, to increase the SNR, the WDs with weak channels should be discouraged from participating in the FL iterations. However, excluding WDs from learning may decrease the learning performance as it reduces the training data size.

In the following, related works in FL are discussed based on their transmission model.

A considerable number of works in FL assume an orthogonal multiple access transmission model for transferring local gradients or local updates from the edge WDs to the network node. Some known methods seek a trade-off between the number of local updates and global rounds by minimizing an FL loss function under a limited resource budget. Formulation of the trade-off between total energy consumption of the edge WDs and the total time of the FL algorithm has been investigated. For example, resource block allocation and WD selection have been studied to minimize the FL loss function. Minimization of FL training delay while considering constraints on overall training performance and differential privacy of each client has also been studied. All of these studies have assumed orthogonal multiple access.

Another group of studies in FL assume an over-the-air-computation model for signal transmission. FL with over-the-air-computation may be categorized based on whether WD selection is performed. Examples of over the air computation without WD selection have been investigated. Examples of over the air computation with WD selection have also been studied. In one known method, in order to increase the received SNR in a cellular network, the edge network node schedules only the cell-interior WDs that are within a threshold distance from the network node. To mitigate the shrinkage of training data, alternating between all-WD scheduling and cell-interior scheduling is implemented. The convergence of over the air model aggregation in FL, incorporating only the WDs with strong channel conditions in the learning process to satisfy the power constraint have also been considered. Some known studies consider a method to determine the receiver beamforming and WD selection with the objective of maximizing the number of selected WDs while bounding the communication error. Reconfigurable intelligent surfaces (RISs) have been used to strengthen channel conditions. An upper bound for the expectation of the loss function was derived to characterize the trade-off between communication error and WD selection error. The WD selection, receiver beamforming, and RIS phase shift have been optimized using Gibbs sampling and the successive convex approximation (SCA) method has been proposed to minimize the upper bound.

There are shortcomings to these and other known methods that contemplate WD selection. Some known methods fail to consider the design of receiver beamforming, and furthermore, choosing a suitable value for the threshold distance may be challenging. A challenge in implementing some approaches is to determine a way to identify the proper threshold value of channel strength. FL training performance is also not considered in some known methods and do not account for the joint impact of WD selection and communication error on the FL convergence rate. Also, in some known methods, algorithm time complexity increases rapidly as the number of WDs increases.

### SUMMARY

Some embodiments advantageously provide methods and network nodes for optimal WD selection and beamforming in federated learning with over-the-air (OTA) aggregation.

Some embodiments apply algorithmic solutions to the problem of optimizing receiver beamforming and WD selection to minimize the loss function in federated learning. Some embodiments use a Greedy Spatial Device Selection (GSDS) method and some embodiments use a Joint Beam Forming Device Selection (JBFDS) method. These two methods have benefits compared to known methods. These benefits may include one or more of lower time complexity and faster convergence speed for model training.

Avoidability: Some embodiments disclosed herein have been demonstrated to perform better than existing methods by simulations. These methods accelerate training convergence with less computational complexity compared to known methods.

Detectability: Some embodiments disclosed herein include determining a receiver beamforming vector and set of selected WDs.

Convergence speed of FL in an over-the-air (OTA) computation setting is improved in a system with one network node and multiple WDs, where the network node is equipped with multiple antennas. Algorithms disclosed herein to improve the convergence speed of FL include:

### 1. Greedy Spatial Device Selection (GSDS):

In this algorithm, the WDs may be chosen based on both their channel strength and channel direction alignment. Appropriate alignment of channel direction improves the performance of receiver beamforming in terms of increased received SNR. Also, receiver beamforming may be designed by an successive convex approximation (SCA) technique.

### 2. Joint Beamforming and Device Selection (JBFDS):

This method is an alternating-optimization approach, in which the receiver beamforming design and the set of selected WDs are determined in sequence, repeatedly. To optimize the receiver beamforming, an SCA technique may be employed, and for finding the optimal set of WDs given beamforming, a threshold-based algorithm may be employed.

Simulations show that these methods, GSDS and JBFDS, both outperform the existing Gibbs sampling method by improving the convergence rate of training in FL with over-the-air computation. Also, these methods benefit from lower time complexity compared with Gibbs sampling. Further, GSDS performs slightly better than JBFDS as it leads to faster convergence rates in simulations. However, the time complexity of GSDS grows faster than that of JBFDS when the number of WDs increases. The simulation results also confirm that when the number of WDs is large, JBFDS enjoys lower run time compared with GSDS.

According to one aspect, a network node configured to communicate with a wireless device (WD) is provided. The network node is configured to receive an over-the-air aggregation of local gradients, each local gradient being transmitted by a different WD of a set of WDs on a same set of time and frequency resources. The network node is configured to determine a set of transmit scalars based at least in part on an objective function of the aggregation of local gradients, each transmit scalar corresponding to at least one WD of the set of WDs. The network node is also configured to transmit the set of transmit scalars, each transmit scalar of the set of transmit scalars being transmitted to a corresponding WD of the set of WDs.

According to this aspect, in some embodiments, the network node is configured to determine a first WD having a highest value of a channel characteristic among a plurality of WDs and adding the determined first WD to the set of WDs between successive determinations of the set of transmit scalars. In some embodiments, the channel characteristic includes one or both of a channel strength and a channel direction. In some embodiments, determining the first WD includes selecting a WD having a highest channel vector projection onto a subspace formed by channel vectors of a set of previously selected WDs. In some embodiments, the network node is configured to determine a receive beamforming vector and wherein determining the set of transmit scalars is based at least in part on the receive beamforming vector. In some embodiments, determining the receive beamforming vector and the set of transmit scalars includes determining a set of selected WDs that optimizes the objective function for a given receiver beamformer. In some embodiments, determining the set of selected WDs that optimizes the objective function includes finding an extrema of the objective function based at least in part on a plurality of successive convex approximations (SCAs). In some embodiments, determining the set of transmit scalars includes optimizing the objective function for a given set of selected WDs. In some embodiments, determining the set of selected WDs is performed jointly for a given receive beamforming vector. In some embodiments, determining the set of transmit scalars includes determining the set of selected WDs and determining the receive beamforming vector alternately and iteratively. In some embodiments, the network node is configured to minimize the objective function subject to a constraint on a maximum value of a term of the objective function, the maximum value depending at least in part on a number of WDs in the set of WDs.

According to another aspect, a method implemented in a network node configured to communicate with a wireless device, WD, is provided. The method includes receiving an over-the-air aggregation of local gradients, each local gradient being transmitted by a different WD of a set of WDs on a same set of time and frequency resources. The method also includes determining a set of transmit scalars based at least in part on an objective function of the aggregation of local gradients, each transmit scalar corresponding to at least one WD of the set of WDs. The method further includes transmitting the set of transmit scalars, each transmit scalar of the set of transmit scalars being transmitted to a corresponding WD of the set of WDs.

According to this aspect, in some embodiments, the method includes determining a first WD having a highest value of a channel characteristic among a plurality of WDs and adding the determined first WD to the set of WDs between successive determinations of the set of transmit scalars. In some embodiments, the channel characteristic includes one or both of a channel strength and a channel direction. In some embodiments, determining the first WD includes selecting a WD having a highest channel vector projection onto a subspace formed by channel vectors of a set of previously selected WDs. In some embodiments, the method includes determining a receive beamforming vector and wherein determining the set of transmit scalars is based at least in part on the receive beamforming vector. In some embodiments, determining the set of transmit scalars includes determining a set of selected WDs that optimizes the objective function for a given receiver beamformer. In some embodiments, determining the set of selected WDs that optimizes the objective function includes finding an extrema of the objective function based at least in part on a plurality of successive convex approximations (SCAs). In some embodiments, determining the set of transmit scalars optimizing the objective function for a given set of selected WDs. In some embodiments, determining the set of selected WDs is performed jointly for a given receive beamforming vector. In some embodiments, determining the set of transmit scalars includes determining the set of selected WDs and determining the receive beamforming vector, alternately and iteratively. In some embodiments, the method includes minimizing the objective function subject to a constraint on a maximum value of a term of the objective function, the maximum value depending at least in part on a number of WDs in the set of WDs.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for optimal device selection and beamforming in federated learning with over-the-air (OTA) aggregation;

FIG. 8 is a flowchart of another example process in a network node for optimal device selection and beamforming in federated learning with over-the-air (OTA) aggregation;

FIG. 9 is a diagram of one example of a federated learning system model according to principles disclosed herein;

FIG. 10 is a flowchart of one example of the GSDS algorithm;

FIG. 11 is a flowchart of an example JBFDS algorithm;

FIG. 12 is a graph of performance averages for known methods and for method disclosed herein; and

FIG. 13 is a graph of average runtime for a known method and for methods disclosed herein.

### DETAILED DESCRIPTION

Before describing in detail example embodiments, it is noted that the embodiments reside primarily in combinations of apparatus components and processing steps related to optimal device selection and beamforming in federated learning with over-the-air (OTA) aggregation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices. Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide optimal device selection and beamforming in federated learning with over-the-air (OTA) aggregation. A device includes a wireless device (WD) but may include wired devices. Thus, although the description that follows discusses embodiments in terms of network nodes (which includes servers) that are configured to select WDs, the same principles disclosed herein may be applied to optimize selection of WDs and/or wired devices.

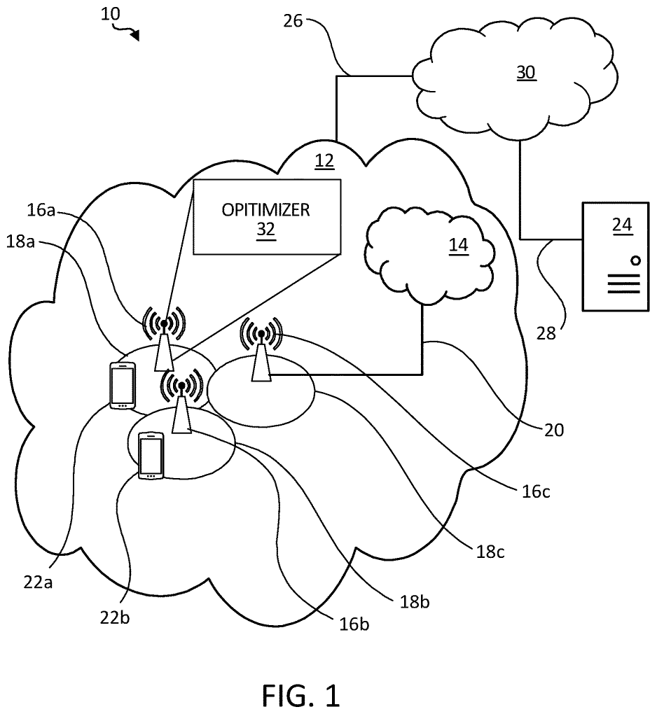

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an optimizer 32 which is configured to determine at least one of a receiver beamformer and a selection of WDs 22 based at least in part on an objective function of a channel vector and a device selection vector. The optimizer 32 may be configured to determine a set of transmit scalars based at least in part on an objective function of an aggregation of local gradients.

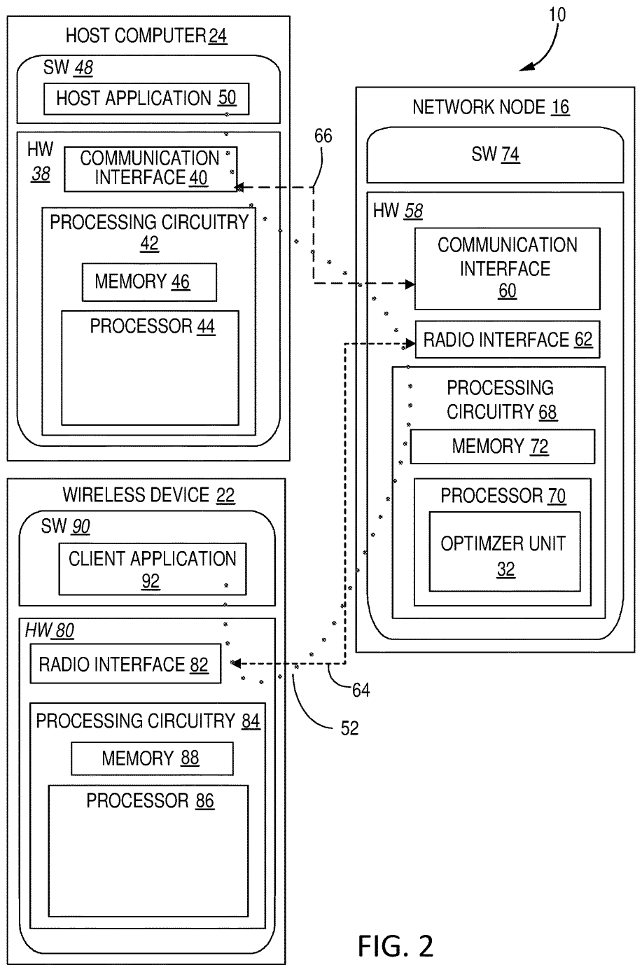

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an optimizer 32 which is configured to determine at least one of a receiver beamformer and a selection of WDs 22 based at least in part on an objective function of a channel vector and a device selection vector. The optimizer 32 may be configured to determine a set of transmit scalars based at least in part on an objective function of an aggregation of local gradients.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as optimizer 32 as being within a processor, it is contemplated that the optimizer 32 may be implemented such that a portion of the unit is stored in a corresponding memory within the processing circuitry. In other words, the optimizer 32 may be implemented in hardware or in a combination of hardware and software within the processing circuitry.

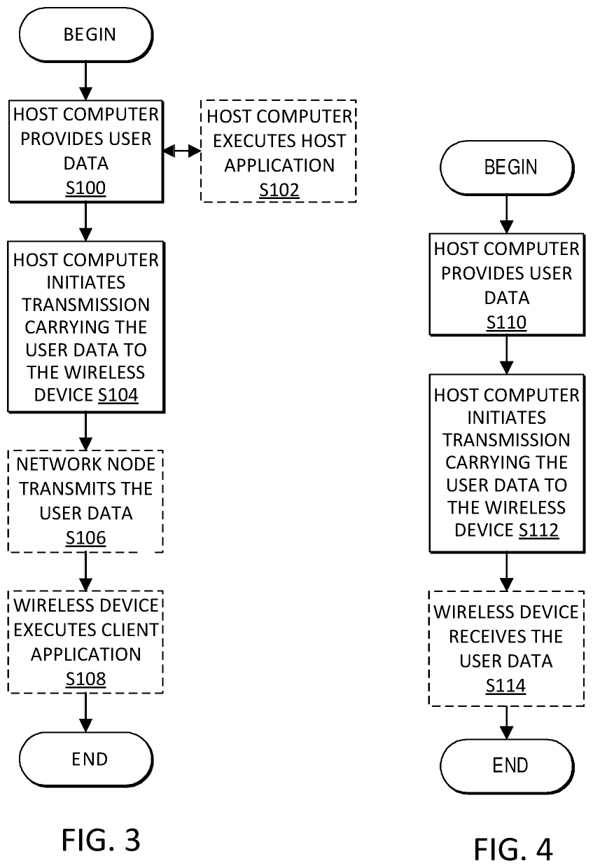

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

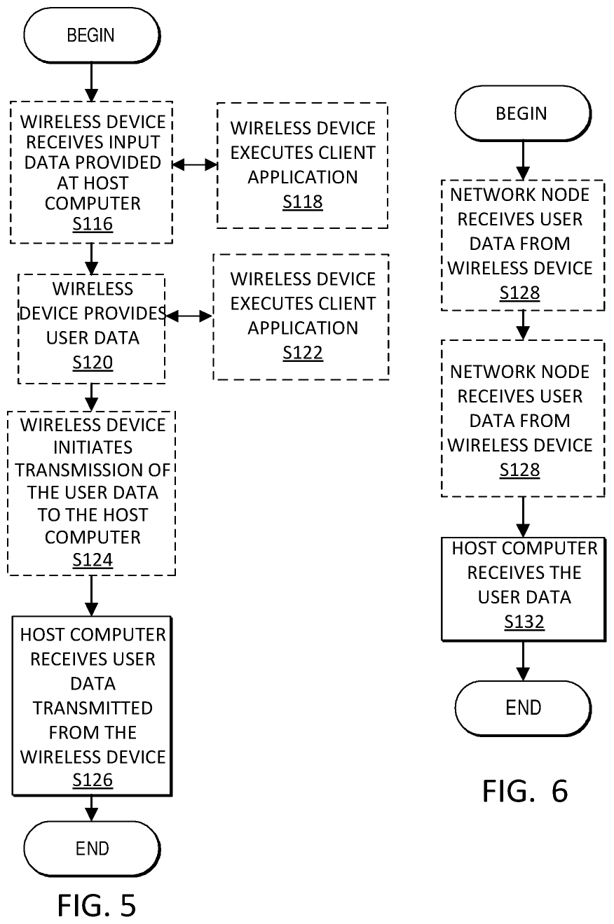

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

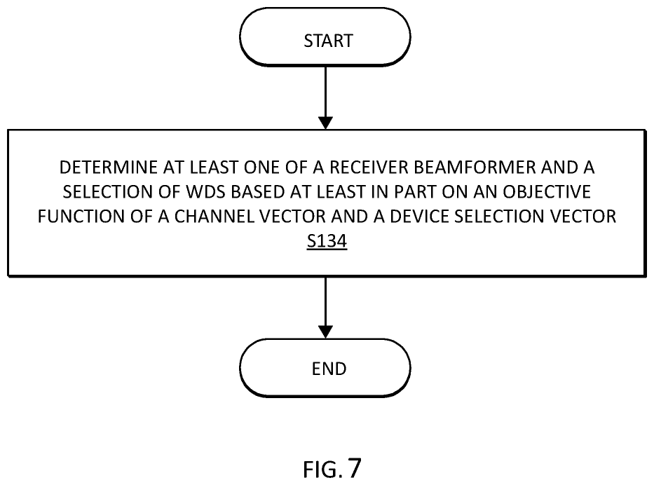

FIG. 7 is a flowchart of an example process in a network node 16 for optimal device selection and beamforming in federated learning with over-the-air (OTA) aggregation. One or more blocks described herein may be performed by one or more elements of network node 16 such as by one or more of processing circuitry 68 (including the optimizer 32), processor 70, radio interface 62 and/or communication interface 60. Network node 16 such as via processing circuitry 68 and/or processor 70 and/or radio interface 62 and/or communication interface 60 is configured to determine at least one of a receiver beamformer and a selection of WDs 22 based at least in part on an objective function of a channel vector and a device selection vector (Block S134).

In some embodiments, determining the least one of a receiver beamformer and a selection of WDs 22 includes successively adding WDs 22 having a channel characteristic that is highest among a plurality of WDs 22 to a set of WDs 22 previously determined to have a channel characteristic that was highest among a plurality of WDs 22. In some embodiments, the channel characteristic includes at least one of a channel strength and a channel direction alignment. In some embodiments, determining the least one of a receiver beamformer and a selection of WDs 22 includes determining a channel vector that has a highest a projection onto a subspace formed by channel vectors of the previously determined set of WDs 22. In some embodiments, determining the least one of a receiver beamformer and a selection of WDs 22 includes finding an extrema of the objective function based at least in part on a plurality of successive convex approximations (SCAs). In some embodiments, determining the at least one of the receiver beamformer and the selection of WDs 22 includes alternately determining a selection of WDs 22 that optimizes the objective function for a given receiver beamformer and determining a set of channel vectors that optimizes the objective function for a given set of selected WDs 22. In some embodiments, the method also includes receiving a plurality of local gradients, each local gradient being transmitted from a different one of a plurality of WDs 22 from which the selected WDs 22 are selected. In some embodiments, the method also includes determining a global loss function based at least in part on the received plurality of local gradients. In some embodiments, determining the global loss function includes inputting the received plurality of local gradients to a neural network. In some embodiments, each WD 22 is configured to weight a local gradient of the WD 22 by a weight so that a received plurality of weighted local gradients are summed over-the-air.

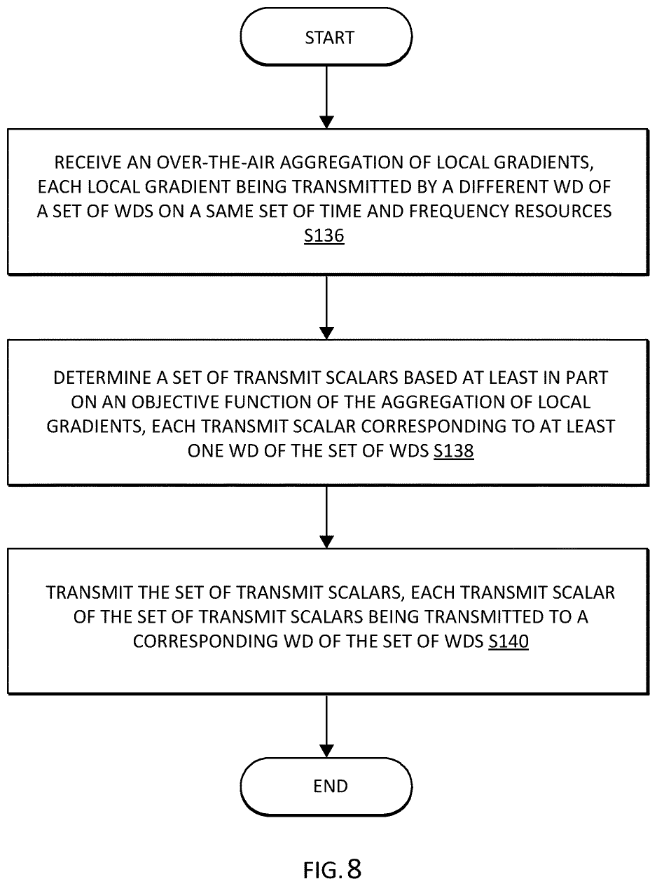

FIG. 8 is a flowchart of another example process in a network node 16 for optimal device selection and beamforming in federated learning with over-the-air (OTA) aggregation. One or more blocks described herein may be performed by one or more elements of network node 16 such as by one or more of processing circuitry 68 (including the optimizer 32), processor 70, radio interface 62 and/or communication interface 60. Network node 16 such as via processing circuitry 68 and/or processor 70 and/or radio interface 62 and/or communication interface 60 is configured to receive an over-the-air aggregation of local gradients, each local gradient being transmitted by a different WD 22 of a set of WDs 22 on a same set of time and frequency resources (Block S136). The method also includes determining a set of transmit scalars based at least in part on an objective function of the aggregation of local gradients, each transmit scalar corresponding to at least one WD 22 of the set of WDs 22 (Block S138). The method further includes transmitting the set of transmit scalars, each transmit scalar of the set of transmit scalars being transmitted to a corresponding WD 22 of the set of WDs 22 (Block S140).

According to this aspect, in some embodiments, the method includes determining a first WD 22 having a highest value of a channel characteristic among a plurality of WDs 22 and adding the determined first WD 22 to the set of WDs 22 between successive determinations of the set of transmit scalars. In some embodiments, the channel characteristic includes one or both of a channel strength and a channel direction. In some embodiments, determining the first WD 22 includes selecting a WD 22 having a highest channel vector projection onto a subspace formed by channel vectors of a set of previously selected WDs 22. In some embodiments, the method includes determining a receive beamforming vector and wherein determining the set of transmit scalars is based at least in part on the receive beamforming vector. In some embodiments, determining the set of transmit scalars includes determining a set of selected WDs 22 that optimizes the objective function for a given receiver beamformer. In some embodiments, determining the set of selected WDs 22 that optimizes the objective function includes finding an extrema of the objective function based at least in part on a plurality of successive convex approximations (SCAs). In some embodiments, determining the set of transmit scalars optimizing the objective function for a given set of selected WDs 22. In some embodiments, determining the set of selected WDs 22 is performed jointly for a given receive beamforming vector. In some embodiments, determining the set of transmit scalars includes determining the set of selected WDs 22 and determining the receive beamforming vector, alternately and iteratively. In some embodiments, the method includes minimizing the objective function subject to a constraint on a maximum value of a term of the objective function, the maximum value depending at least in part on a number of WDs 22 in the set of WDs 22.

Having described the general process flow of arrangements of the disclosure and having provided examples of hardware and software arrangements for implementing the processes and functions of the disclosure, the sections below provide details and examples of arrangements for optimal device selection and beamforming in federated learning with over-the-air (OTA) aggregation.

### System Model

### FL System

A federated system is assumed to include one parameter server, hereafter referred to as a network node 16 and M edge devices, hereafter referred to as WDs 22, hereafter referred to as devices or as WDs 22. A goal may be to minimize a global loss function that is the empirical loss over training samples and is defined as:

$$F ( w ) = \frac{1}{K} {\sum }_{k = 1}^{K} l ( w ; {x}_{k} , {y}_{k} ) , \qquad ( 1 )$$

where w is the model parameter vector, xₖ is the kth training sample input, yₖ is its corresponding label, l(.) is the loss function, and K is the total number of training samples. Note that minimizing a loss function may in some embodiments be cast as maximizing, minimizing or optimizing an objective function. Assume that the training data is distributed among the edge WDs 22 and the mth WD 22 has a local dataset with size Kₘ and denoted by [symbol] ₘ={(x_{m,k}, y_{m,k}): 1≤k≤Kₘ}. The global loss function defined in (1) may be rewritten as:

$$F ( w ) = \frac{1}{K} {\sum }_{m = 1}^{M} {K}_{m} {F}_{m} ( w ; {𝒟}_{m} ) , \qquad ( 2 )$$

where Fₘ(w; [symbol] ₘ) is the local loss function for WD 22 m and is defined as:

$${F}_{m} ( w ; {𝒟}_{m} ) {=}^{Δ} \frac{1}{{K}_{m}} {\sum }_{( {x}_{m , k} , {y}_{m , k} ) ∈ {𝒟}_{m}} l ( w ; {x}_{m , k} , {y}_{m , k} ) . \qquad ( 3 )$$

The general FedSGD approach for model training in FL may be followed, where the network node 16 updates the model parameters based on an aggregation of the gradients of all WDs' local loss functions. Assume all WDs 22 compute the full batch gradient and send it to the network node 16. Each iteration of the algorithm is called a communication round and is denoted by t. Within each communication round, some or all of the following steps may be performed:

### 1. Device Selection:

The network node 16 selects a subset of WDs 22 to contribute in the training of the model. The set of selected WDs 22 in round t is denoted by [symbol] ₜ{1, 2, . . . , M}.

### 2. Downlink Phase:

The network node 16 broadcasts the model parameter vector wₜ to all WDs 22.

### 3. Gradient Computation:

Each selected WD 22 computes the gradient of its local loss function at wₜ, which is denoted by:

g_{m,t}≙∇Fₘ(wₜ; [symbol] ₘ), (4)

where ∇Fₘ(wₜ; [symbol] ₘ) is the gradient of Fₘ(.) at wₜ.

4. Uplink phase: The selected WDs 22 send their local gradients to the network node 16 through the uplink wireless channels.

### 5. Model Updating:

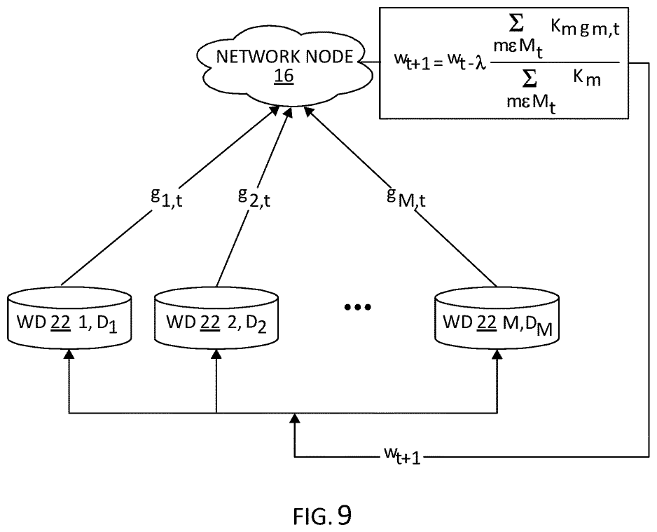

The network node 16 may use a weighted summation of local gradients to update the parameter model. In some scenarios, when all of the local gradients may be transmitted to the network node 16 accurately, rₜ≙ [symbol] Kₘg_{m,t} is used to update the model parameter vector (because it is equal to the gradient of global loss function). However, in reality, only an estimation of rₜ, denoted by \hat{r}ₜ, may be obtained at the network node 16, due to the communication noise and wireless channel fading. The network node 16 uses \hat{r}ₜ to update the model parameter vector based on:

$${w}_{t + 1} = {w}_{t} - \frac{λ}{{\sum }_{m ∈ {ℳ}_{t}} {K}_{m}} {\hat{r}}_{t} , \qquad ( 5 )$$

where λ is the learning rate, which may or may not be time varying. An example FL system model is shown in FIG. 9, where all of the local gradients may be transmitted to the network node 16 without distortion.

### Over-the-Air Analog Aggregation

Assume each WD 22 has a single antenna and the network node 16 is equipped with N antennas. The channel condition between WD 22 m and the network node 16 may be denoted by hₘ∈ [symbol] ^{N×1}. The dimension of the parameter vector is assumed to be D and therefore, the local gradients are D dimensional vectors.

Over-the-air computation may be used to obtain the aggregation of local gradients at the network node 16. Different WDs 22 send their local gradients to the network node 16 on the same time and frequency resources. By adjusting the transmit scalars for each WD 22, the appropriate summation of local gradients is received at the network node 16. Denote entry d of g_{m,t} by g_{m,t}[d], and without loss of generality, consider D time slots for transmitting the different entries of local gradients. In time slot d, the selected WDs 22 send entry d of their local gradients. Define the mean and variance of each local gradient as:

$${\overline{g}}_{m , t} = \frac{1}{D} {\sum }_{d = 1}^{D} {g}_{m , t} [ d ] , \qquad ( 6 )$$

$${v}_{m , t}^{2} = \frac{1}{D} {\sum }_{d = 1}^{D} {( {g}_{m , t} [ d ] - {\overline{g}}_{m , t} )}^{2} . \qquad ( 7 )$$

In each communication round, each selected WD 22 m sends the scalar values g̅_{m,t} and v_{m,t} to the network node 16. Since these scalars contain negligible information content compared with the gradients, assume that they are sent over separate digital channels and their transmission is error-free. Each WD 22 may first normalize its local gradient using g̅_{m,t} and v_{m,t}, and then adjust the transmit scalar and send the local gradient. More precisely, the transmit signal for WD 22 m in communication round t and time slot d is denoted by x_{m,t}[d] and defined as

$${x}_{m , t} [ d ] = {a}_{m , t} \frac{{g}_{m , t} [ d ] - {\overline{g}}_{m , t}}{{v}_{m , t}} , \qquad ( 8 )$$

where a_{m,t}∈ [symbol] is the transmit scalar of WD 22 m at communication round t. Eq (8) guarantees [symbol] [|x_{m,t}[d]|]=|a_{m,t}|², which implies that the power of the transmit signal is |a_{m,t}|². Considering the power constraint for each WD 22, the transmit power of each WD 22 may be bounded by P₀:

|a_{m,t}|²≤P₀,∀m,∀t. (9)

The received signal at the network node 16 in communication round t and time slot d is denoted by yₜ[d]:

$${y}_{t} [ d ] = {\sum }_{m ∈ {ℳ}_{t}} {h}_{m} {a}_{m , t} \frac{( {g}_{m , t} [ d ] - {\overline{g}}_{m , t} )}{{v}_{m , t}} + {n}_{d , t} , \qquad ( 10 )$$

where n_{d,t}∈ [symbol] ^{N} is the additive white Gaussian noise in communication round t and time slot d, and

$${n}_{d , t} ∼ 𝒞𝒩 ( 0 , {σ}_{n}^{2} {I}_{N \times N} )$$

where

$${σ}_{n}^{2}$$

is the variance of each element of the noise vector. Assume that n_{d,t} in different rounds are independent of each other.

To calculate entry d of \hat{r}ₜ, which is denoted by \hat{r}ₜ[d], the network node 16 may apply a normalized receiver beamforming vector denoted by fₜ∈ [symbol] ^{N}, ∥fₜ∥=1 and some normalization scalar ηₜ∈ [symbol] ⁺ to the received signal in time slot d, which may be expressed as:

$${\hat{r}}_{t} [ d ] = \frac{1}{\sqrt{{η}_{t}}} {f}_{t}^{H} {y}_{t} [ d ] + {\overline{g}}_{t} = \frac{1}{\sqrt{{η}_{t}}} ( {\sum }_{m ∈ {ℳ}_{t}} {f}_{t}^{H} {h}_{m} {a}_{m , t} \frac{( {g}_{m , t} [ d ] - {\overline{g}}_{m , t} )}{{v}_{m , t}} + {f}_{t}^{H} {n}_{d , t} ) + {\overline{g}}_{t} , \qquad ( 11 )$$

where g̅ₜ≙ [symbol] Kₘg̅_{m,t} is added to (11) to compensate for the subtraction of mean values in (8).

### Problem Formulation

Some embodiments seek to increase the convergence speed of training by minimizing the global loss function after T communication rounds. Due to the randomness of the noise, the expectation of global loss function over noise may be minimized after T rounds by optimizing the receiver beamforming, the set of selected WDs 22, transmit scalars, and normalization scalar. Therefore, the following optimization problem may be solved in some embodiments:

$$\begin{matrix}min \\ \{ {f}_{t} , {x}_{t} , {a}_{m , t} , {η}_{t} ; ∀ 0 \leq t \leq T \}\end{matrix} 𝔼 [ F ( {w}_{T} ) ] \qquad ( 12 )$$

$$s . t . {\vert {a}_{m , t} \vert}^{2} \leq {P}_{0} , ∀ m , ∀ 0 \leq t \leq T , \qquad ( 13 )$$

$${x}_{t} ∈ {\{ 0 , 1 \}}^{M} , ∀ 0 \leq t \leq T , \qquad ( 14 )$$

$$‖ {f}_{t} ‖ = 1 , ∀ 0 \leq t \leq T , \qquad ( 15 )$$

where xₜ∈{0,1}^{M} is the WD selection vector at round t. Note that when entry i of xₜ, denoted by x_{t,i}, equals to 1, this indicates WD 22 i's participation in the learning.

### Training Convergence Rate Analysis

The updating rule at the network node 16 in (5) may be rewritten as:

wₜ₊₁=wₜ−λ(∇F(wₜ)−eₜ), (16)

where ∇F(wₜ) is the gradient of global loss function at wₜ, and eₜ is the error vector which denotes the deviation of the direction of updating from the true direction of updating (i.e., if the exact gradient of the global loss function were known). Note that eₜ may be decomposed into two terms as follows:

$${e}_{t} = ∇ F ( {w}_{t} ) - \frac{{\hat{r}}_{t}}{{\sum }_{m ∈ {ℳ}_{t}} {K}_{m}} = {\underbrace{∇ F ( {w}_{t} ) - \frac{{r}_{t}}{{\sum }_{m ∈ {ℳ}_{t}} {K}_{m}}}}_{{e}_{1 , t}} + {\underbrace{\frac{{r}_{t}}{{\sum }_{m ∈ {ℳ}_{t}} {K}_{m}} - \frac{{\hat{r}}_{t}}{{\sum }_{m ∈ {ℳ}_{t}} {K}_{m}}}}_{{e}_{2 , t}} , \qquad ( 17 )$$

where e_{1,t} is the WD selection error. If all WDs 22 were selected, this term would be zero; and e_{2,t} is the communication error due to the communication noise and channel fading, rₜ≠\hat{r}ₜ and therefore e_{2,t}≠0. Furthermore, given [symbol] ₜ, the optimal {ηₜ, a_{m,t}, ∀ₘ} that minimizes [symbol] [∥e_{2,t}∥²] may be expressed as:

$${η}_{t} = {min}_{m ∈ {M}_{t}} \frac{{P}_{0} {\vert {f}^{H} {h}_{m} \vert}^{2}}{{K}_{m}^{2} {v}_{m , t}^{2}} \qquad ( 18 )$$

$${a}_{m , t} = \frac{{K}_{m} \sqrt{{η}_{t}} {{v}_{m , t} ( {f}^{H} {h}_{m} )}^{H}}{{\vert {f}^{H} {h}_{m} \vert}^{2}} . \qquad ( 19 )$$

One or more of the following four assumptions on the global loss function may be made:
A1. F(w) is strongly convex with parameter u:

$$F ( w ) \geq F ( {w}^{′} ) + {( w - {w}^{′} )}^{T} ∇ F ( {w}^{′} ) + \frac{μ}{2} {‖ w - {w}^{′} ‖}_{2}^{2} . \qquad ( 20 )$$

A2. The gradient ∇F(w) is Lipschitz continuous with parameter L:

∥∇F(w)−∇F(w′)∥₂≤L∥w−w′∥₂. (21)
A3. F(w) is twice continuously differentiable.
A4. The gradient of the loss function on each training data sample is upper bounded:

$${‖ ∇ l ( {w}_{t} ; {x}_{k} , {y}_{k} ) ‖}_{2}^{2} \leq {α}_{1} + {α}_{2} {‖ ∇ F ( {w}_{t} ) ‖}_{2}^{2} , ∀ k , ∀ t , \qquad ( 22 )$$

for some given constants α₁≥0 and α₂≥1.

Denote the minimizer of F(w) by w*. If the following conditions apply: (i) normalization scalar and the transmitter scalars are chosen based on (18) and (19) respectively, (ii) the loss function satisfies A1-A4, and (iii)

$$λ = \frac{1}{L} ,$$

then the expectation of the global loss function at iteration t+1 is upper bounded by:

$$𝔼 [ F ( {w}_{t + 1} ) - F ( {w}^{*} ) ] \leq {ψ}_{t} 𝔼 [ F ( {w}_{t} ) - F ( {w}^{*} ) ] + \frac{{α}_{1} d ( {f}_{t} , {x}_{t} )}{L} , \qquad ( 23 )$$

$$where$$

$${ψ}_{t} = 1 - \frac{μ}{L} ( 1 - 2 {α}_{2} d ( {f}_{t} , {x}_{t} ) ) , \qquad ( 24 )$$

$$d ( {f}_{t} , {x}_{t} ) = \frac{4}{{K}_{2}} {( {\sum }_{m} ( 1 - {x}_{t , m} ) {K}_{m} )}^{2} + \frac{{σ}_{n}^{2}}{{{P}_{0} ( {\sum }_{m} {x}_{t , m} {K}_{m} )}^{2}} {max}_{m} \frac{{x}_{t , m} {K}_{m}^{2}}{{\vert {f}_{t}^{H} {h}_{m} \vert}^{2}} . \qquad ( 25 )$$

Substituting different times in (23), a set of inequalities are obtained from which it may be concluded that:

$$𝔼 [ F ( {w}_{T} ) - F ( {w}^{*} ) ] \leq {ψ}_{T - 1} {ψ}_{T - 2} … {ψ}_{0} 𝔼 [ F ( {w}_{0} ) - F ( {w}^{*} ) ] + \frac{{α}_{1}}{L} ( {\sum }_{j = 0}^{T - 1} {B}_{T - 1 - j} d ( {f}_{j} , {x}_{j} ) ) , \qquad ( 26 )$$

where Bⱼ=ψ_{T-j}Bⱼ₋₁, ∀T≥j≥1, B₀=1, and w₀ is the initial model parameter vector.

### Design of Receiver Beamforming and Set of Selected Devices

The design of receiver beamforming as well as the WD selection to improve the convergence speed of training is further disclosed below. First, a problem reformulation is presented and then, the methods for solving the problem are described.

### Problem Reformulation

Since the objective function [symbol] [F(w_{T})] in (12) is not an explicit function of optimization variables, it is hard to directly minimize it. Therefore, instead minimize its upper bound in (26). Since ψₜ is an increasing function of d(fₜ, xₜ) and the upper bound in (26) includes multiplication of ψ and d(.) in different rounds which are independent of each other, to minimize the upper bound in (26), it is sufficient to minimize d(.) in each round as follows:

$$\begin{matrix}{min}_{f , x} & d ( f , x )\end{matrix} \qquad ( 27 )$$

$$\begin{matrix}s . t . & ‖ f ‖ = 1 ,\end{matrix} \qquad ( 28 )$$

$$x ∈ {\{ 0 , 1 \}}^{M} \qquad ( 29 )$$

Note that the subscript t has been removed since d(.) depends on t only through the optimization variables fₜ and xₜ. In other words, this optimization problem needs to be solved only once for all time slots.

### Solving the Problem Given Device Selection

Equation (27) may be solved given the set of selected WDs 22 When the WD selection vector xₜ is given, (27) may be simplified to:

$${min}_{f} {max}_{m} \frac{{x}_{m} {K}_{m}^{2}}{{\vert {f}^{H} {h}_{m} \vert}^{2}} \qquad ( 30 )$$

$$\begin{matrix}s . t . & ‖ f ‖ = 1.\end{matrix} \qquad ( 31 )$$

Introducing an auxiliary variable s, re-write (30) as:

$$\begin{matrix}{min}_{f , s} & s\end{matrix} \qquad ( 32 )$$

$$\begin{matrix}s . t . & \frac{{x}_{m} {K}_{m}^{2}}{{\vert {f}^{H} {h}_{m} \vert}^{2}} \leq s\end{matrix} \qquad ( 33 )$$

$$‖ f ‖ = 1. \qquad ( 34 )$$

If a change of variable, f′≙\sqrt{sf}, is applied, an equivalent problem for (32) may be expressed as:

$${min}_{{f}^{′}} {‖ {f}^{′} ‖}^{2} \qquad ( 35 )$$

$$\begin{matrix}s . t . & {\vert {f}^{′ H} {h}_{m} \vert}^{2} \geq {K}_{m}^{2} {x}_{m} .\end{matrix} \qquad ( 36 )$$

Problem (35) is a well-known problem called “single group multicast beamforming” and may be solved by an SCA method, which guarantees convergence to a K.K.T. The solution to (35) may be used to construct some of the methods disclosed herein. The time complexity of solving problem (35) by the SCA method is [symbol] (IₘₐₓN³), where Iₘₐₓ is the maximum number of iterations of SCA.

### Greedy Spatial Device Selection (GSDS)

The strength and direction of channels of the set of selected WDs 22 may both affect the value of d(.). More channel direction diversity leads to an increase in the value of d(.), since it is more difficult to find a beamforming vector that is well aligned with all channel directions. Also, channel strengths also affect the value of d(.), such that a decrease in channel strengths would increase the value of d(.). Motivated by the above consideration, an algorithm named Greedy Spatial Device Selection (GSDS) is disclosed. In each step of the algorithm, the WD 22 with maximum channel alignment and channel strength is appended to the set of selected WDs 22.

Let S denote the set of all WDs 22. In the first step, GSDS selects the WD 22 with the strongest channel condition and incrementally expands the set of selected WDs 22. Denote the set of selected WDs 22 in step i of the algorithm by Sᵢ, 1≤i≤M, where S₁ only contains the WD 22 with a largest channel norm (∥hₘ∥) and Sᵢ contains i WDs 22. In each step, to compose a new set of selected WDs 22, GSDS may select the WD 22 with the highest merit and append it to the set of selected WDs 22 in the previous step. The merit of each WD 22 for being selected is measured by its channel vector projection norm on the subspace generated by channel vectors of previously selected WDs 22, which includes both channel strength and channel direction alignment of the newly selected WD 22.

More precisely, in step i, GSDS may compute the projection of the channel vectors of WDs 22 in S\Sᵢ₋₁ on the subspace generated by channel vectors of WDs 22 in Sᵢ₋₁ and chooses the WD 22 with the largest value of channel vector projection norm among WDs 22 in S\Sᵢ₋₁. The label of this newly selected WD 22 is represented by cᵢ and may be used to update the set of selected WDs 22 according to:

Sᵢ=Sᵢ₋₁∪cᵢ. (37)

Let xᵢ be the WD selection vector corresponding to Sᵢ. After xᵢ is found, (30) is solved using the SCA method to obtain the receiver beamforming, which is denoted by fᵢ. Then, the value of d(xᵢ, fᵢ) along with fᵢ and xᵢ are stored and the next step starts. After performing step M, the stored values for d(.) in different steps are compared and the set of selected WDs 22 and beamforming vector corresponding to the minimum value of d(.) may be returned as the output of the GSDS.

This procedure is summarized in Algorithm 1.

Algorithm 1: Greedy Spatial Device Selection (GSDS)

```
  1: Initialization: Initialize S to the set of all WDs 22 and S₀ to Ø.
  2: for i = 1, ... , M do
```

| | |
|---|---|
| 1. | if i = 1 then |

Among all WDs 22, choose the one that has the largest channel norm and
denote its label by cᵢ.

| | |
|---|---|
| 2. | else |

Among all WDs 22 in S\ Sᵢ₋₁, choose the one whose channel vector
projection on the subspace generated by channel vectors of WDs 22 in Sᵢ₋₁ has the
maximum norm. Denote this WD 22 by cᵢ.

| | |
|---|---|
| 3. | end if |
| 4. | Sᵢ = Sᵢ₋₁ ∪{cᵢ} |
| 5. | Generate the WD selection vector xᵢcorresponding to Sᵢ. |

```
Solve (30) to find the beamforming vector fᵢ. Store xᵢ, fᵢ, and d( fᵢ,xᵢ ).
  3: end for
  4: Compare the stored values of d(.), and choose the WD selection set and
the beamforming vector corresponding to the minimum value of d(.).
```

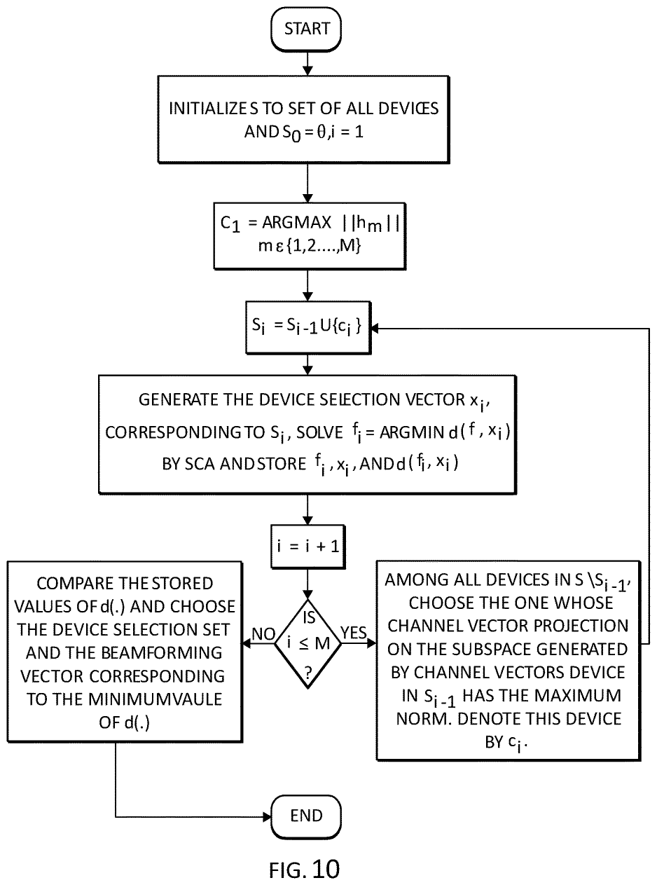

The time complexity of GSDS is [symbol] (IₘₐₓN³M+NM³). Since GSDS runs the SCA method M times, when the number of WDs 22 is large, it takes a considerable time to solve the problem. Therefore, another method disclosed herein has a lower time complexity in terms of M. FIG. 10 is a flowchart of one example of the GSDS algorithm.

### Joint Beamforming and Device Selection (JBFDS)

An alternating-optimization approach is disclosed for jointly finding the WD selection and receiver beamforming, which is termed the Joint Beamforming and Device Selection (JBFDS) algorithm. In each iteration of JBFDS, the set of selected WDs 22 and receiver beamforming are optimized iteratively and alternatingly. Before presenting JBFDS, an algorithm for finding the optimal set of selected WDs 22 assuming the beamforming vector is given. This algorithm may serve as one basis of JBFDS.

### Solving (27) Given Beamforming

When the beamforming vector fᵢ is given, the optimization problem of equation (27) reduces to

$$\begin{matrix}min \\ x\end{matrix} \frac{4 {( {\sum }_{m} ( 1 - {x}_{m} ) {K}_{m} )}^{2}}{{K}^{2}} + \frac{{σ}_{n}^{2}}{{{P}_{0} ( {\sum }_{m} {x}_{m} {K}_{m} )}^{2}} \begin{matrix}max \\ m\end{matrix} \frac{{x}_{m} {K}_{m}^{2}}{{\vert {f}^{H} {h}_{m} \vert}^{2}} \qquad ( 38 )$$

$$\begin{matrix}s . t . & x ∈ {\{ 0 , 1 \}}^{M} .\end{matrix} \qquad ( 39 )$$

The objective function in (38) includes two terms. The second term contains maximization over M items. In general, this maximum value may be equal to any of

$$\frac{{K}_{m}^{2}}{{\vert {f}^{H} {h}_{m} \vert}^{2}} ,$$

∀1≤m≤M. In some embodiments for solving (38), it may be assumed that the maximization term takes each of the M possible values and in each case, the minimum value of the objective function may be attained by selecting all WDs 22 whose corresponding value of

$$\frac{{K}_{m}^{2}}{{\vert {f}^{H} {h}_{m} \vert}^{2}}$$

is less than or equal to the maximization term. The reason for such a selection is that given a fixed value of the maximization term, the more WDs 22 that are selected, the less would be the value of objective function. This motivates selection of all WDs 22 with the value of

$$\frac{{K}_{m}^{2}}{{\vert {f}^{H} {h}_{m} \vert}^{2}}$$

less than the maximization term. Then, the values of the objective function in each of these cases may be compared and their minimum value together with its corresponding WD selection are returned as the output of the algorithm. This procedure is summarized in Algorithm 2.

Algorithm 2: Optimal Device Selection Given Beamforming

```
    1: Input: Beamforming vector f.
    $2 : Sort the value of \frac{{K}_{m}^{2}}{{\vert {f}^{H} {h}_{m} \vert}^{2}} in increasing order :$
$\frac{{K}_{{i}_{1}}^{2}}{{\vert {f}^{H} {h}_{{i}_{1}} \vert}^{2}} \leq \frac{{K}_{{i}_{2}}^{2}}{{\vert {f}^{H} {h}_{{i}_{2}} \vert}^{2}} \leq … \leq \frac{{K}_{M}^{2}}{{\vert {f}^{H} {h}_{{i}_{M}} \vert}^{2}} \qquad ( 40 )$
    3: for j = 1, 2, ... , M do
        Form z^{(j)} based on
${z}_{m}^{( j )} = \{ \begin{matrix}1 , & for m = {i}_{1} , {i}_{2} , … , {i}_{j} \\ 0 , & otherwise\end{matrix} . \qquad ( 41 )$
    4: end for
    5: Among z⁽ⁱ⁾, ... , z^{(M)}, choose the one that has the minimum value of
d(f, z^{(j)} and denote it by x.
    6: Output: x
```

The optimality of Algorithm 2 may be stated in the following theorem.

Theorem 1: Algorithm 2 finds a global optimal point for problem (38).

Proof of Theorem 1: Assume y is an arbitrary WD selection vector and assign each WD 22 a label based on (40). Consider Z≙{z^{(j)}:1≤j≤M} where z^{(j)} is defined in (41). Let iₗ be the WD 22 with the largest value of

$$\frac{{K}_{m}^{2}}{{\vert {f}^{H} {h}_{m} \vert}^{2}}$$

among the WDs 22 that vector y chooses. Therefore, the set of selected WDs 22 based on y is a subset of {i₁, i₂, . . . , iₗ}. Now, compare the value of d(f, y) with d(f, z^{(l)}). Based on the definition of the objective function in (25), it may be concluded that d(f, z^{(l)})≤d(f, y). Therefore, for any arbitrary WD selection vector, there is a better vector in Z and so for finding the global optimal point, it is enough to choose the best vector in Z.

After identifying the optimal set of WDs 22 given the receiver beamforming by Algorithm 2, as well as the sub-optimal receiver beamforming given the set of selected WDs 22 by the SCA method, the JBFDS algorithm may be performed using the disclosed alternating-optimization approach for minimizing d(.). JBFDS is summarized in Algorithm 3.

Algorithm 3: Joint Beamforming and Device Selection (JBFDS)

```
    1: Input: Jₘₐₓ.
    2: Initialization: Set x⁽⁰⁾ to the all-one vector and initialize f⁽⁰⁾.
    3: for j = 1, 2, ... , Jₘₐₓ do
    $1. Solve {x}^{( j )} = \begin{matrix}arg min \\ x ∈ {\{ 0 , 1 \}}^{M}\end{matrix} d ( {f}^{( j - 1 )} , x ) by Algorithm 2.$
    $2. Solve {f}^{( j )} = \begin{matrix}arg min \\ \{ f : ‖ f ‖ = 1 \}\end{matrix} d ( f , {x}^{( j )} ) by SCA .$
    3. If d(f^{(j)}, x^{(j)}) − d(f^{(j-1)}, x^{(j)}) ≥ 0 then
    f^{(j)} = f(^{j-1}) and Break
    4: end for
    5: Output: f^{(j)}, x^{(j)}.
```

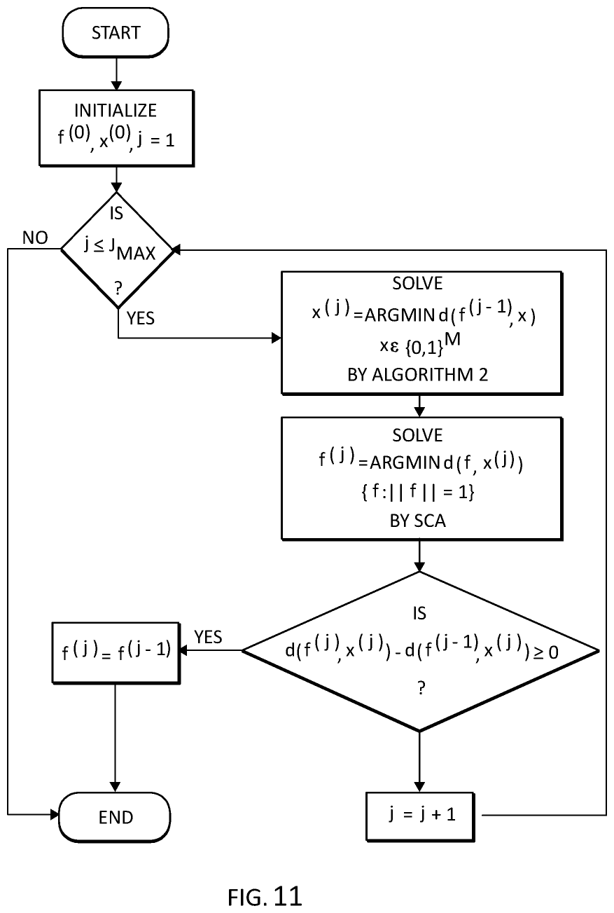

The convergence of JBFDS may be guaranteed, since during the iterations of JBFDS, the value of the objective function is non-increasing and the objective function is bounded below (by zero). The time complexity of solving problem (38) by Algorithm 2 is [symbol] (M²+MN). Therefore, the overall time complexity of JBFDS is [symbol] (Jₘₐₓ(IₘₐₓN³+M²+MN)), where Jₘₐₓ is the maximum number of iterations of the JBFDS algorithm. FIG. 11 is a flowchart of an example JBFDS algorithm.

### Simulation Results

### Simulation Setting

An image classification task based on the MNIST dataset has been simulated. The dataset includes of 60000 training samples and 10000 test samples, and the samples belong to ten different classes. Each data sample is an image of size 28×28 pixels, i.e., xₖ∈ [symbol] ⁷⁸⁴, and its label yₖ∈{0, 1, . . . , 9} indicates to which class it belongs. Consider training a multinomial logistic regression classifier on the images. Thus, for each class there is a 785 dimensional parameter vector, in which the first 784 entries together are the weight vector and the last entry is the bias term. The parameter vector of class j is denoted by w[j]∈ [symbol] ⁷⁸⁵. The model parameter vector is the concatenation of the parameter vectors of different classes, i.e., w=[w[0]^{T}, w[1]^{T}, . . . , w[9]^{T}]^{T} and thus D=7850. The loss function is cross-entropy

$$l ( w ; {x}_{k} , {y}_{k} ) = - {\sum }_{j = 0}^{9} 1 \{ {y}_{k} = j \} log \frac{exp ( {u}_{k}^{T} w [ j ] )}{{\sum }_{i = 0}^{9} exp ( {u}_{k}^{T} w [ i ] )} , where {u}_{k} = {[ {x}_{k}^{T} , 1 ]}^{T} . \qquad ( 42 )$$

Assume M=50 WDs 22 and distribute the training data samples among the WDs 22 in a way such that every WD 22 has 108 data samples from each of the classes and thus, the local dataset in each WD 22 has 1080 data samples, i.e., Kₘ=1080, ∀m and

$$K = {\sum }_{m = 1}^{M} {K}_{m} = 54000 .$$

The distance of WD 22 m from the network node 16, denoted by dₘ, is sampled from a uniform distribution, i.e., dₘ~U[rₘᵢₙ, rₘₐₓ]. The channel vector for WD 22 m is sampled from a Complex Normal distribution with covariance matrix equal to

$$\frac{C}{{d}_{m}^{3}} {I}_{N \times N} , i . e . , {h}_{m} ∼ 𝒞𝒩 ( 0 , \frac{C}{{d}_{m}^{3}} {I}_{N \times N} )$$

parameters are shown in Table 1.

TABLE 1
Simulation Parameters

| Parameter | Value | Parameter | Value |
|---|---|---|---|
| N | 4 | C | 1 |
| M | 50 | rₘᵢₙ | 10 m |
| $\frac{{P}_{0}}{{σ}^{2}}$ | −10 dB | rₘₐₓ | 100 m |
| λ | 0.05 | K | 54000 |

### Comparison Benchmarks

In these simulations, one or more of the following example benchmarks may be considered.

1. Error-free Centralized Learning: In this scheme, assume all of the local gradients exist in the network node 16 and that they are not transmitted, thereby avoiding communication issues in this scheme, and serving as an upper bound for these simulations.

2. Select All: Assume all of the clients are selected to contribute in the FL training, and use SCA to find the receiver beamforming to minimize the loss function upper bound.

3. Select Top One: Assume only the client with the strongest channel condition is selected to contribute in the FL training, and in this single-device case the optimal receiver beamforming may be computed to minimize the loss function upper bound.

4 Gibbs Sampling: In this method, Gibbs sampling is used to determine the set of selected WDs 22 and receiver beamforming is obtained using SCA. The time complexity of this method depends on the type of the SCA method that used. If one known SCA method is applied, the time complexity is [symbol] (IₘₐₓJₘₐₓM⁴) and if another known SCA method in is employed, the time complexity is [symbol] (IₘₐₓJₘₐₓN³M). The second approach was utilized as its time complexity is less than the first one in terms of M and M usually is much larger than N in large-scale FL. It is also the same SCA method used in GSDS and JBFDS.

Assume that during the FL training, channel conditions are fixed, and before the start of the training, the set of selected WDs 22 and receiver beamforming are obtained using the considered methods. In the simulations, different random realizations of the distances of WDs 22 from the network node 16 are used, and for each realization, the receiver beamforming and set of selected WDs 22 are optimized and then used to train the model.

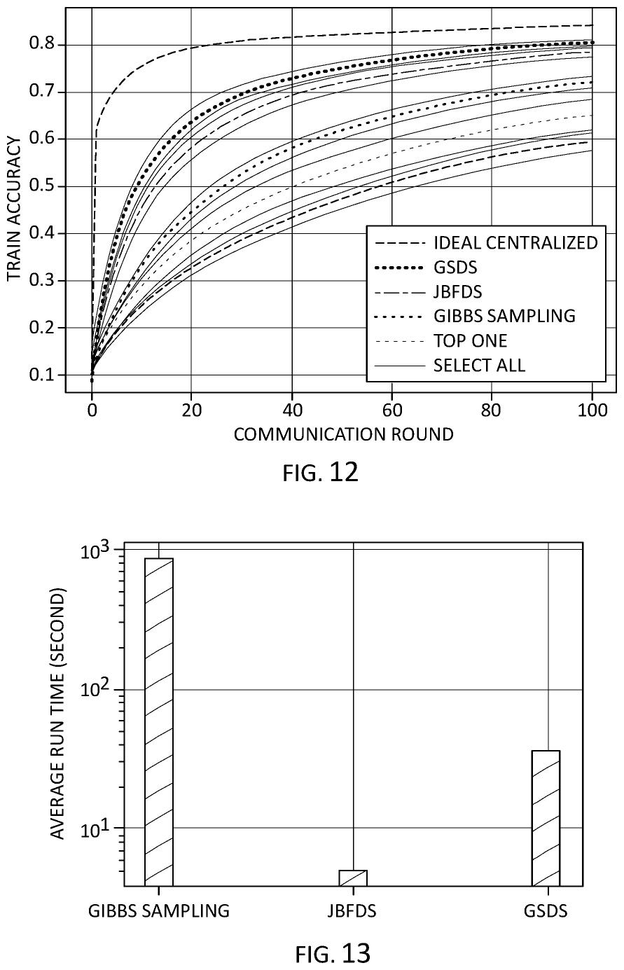

In FIG. 12, the average performances of all methods over different channel realizations and different samples of communication noise are reported. FIG. 12 shows the average train accuracy with 95% confidence intervals for different methods as the communication rounds progress. Both JBFDS and GSDS result in higher convergence speed compared with the benchmarks. Furthermore, GSDS leads to higher accuracy than JBFDS.

FIG. 13 shows the average run time for different methods, which demonstrates that both GSDS and JBFDS have substantially reduced computational complexity compared with Gibbs sampling. It also suggests that JBFDS has lower computational complexity than GSDS despite its slight reduction in FL training performance.

Some embodiments may include one or more of the following:

Embodiment A1. A network node configured to communicate with a wireless device (WD), the network node configured to, and/or comprising a radio interface and/or comprising processing circuitry configured to:
determine at least one of a receiver beamformer and a selection of WDs based at least in part on an objective function of a channel vector and a device selection vector.

Embodiment A2. The network node of Embodiment A1, wherein determining the least one of a receiver beamformer and a selection of WDs includes successively adding WDs having a channel characteristic that is highest among a plurality of WDs to a set of WDs previously determined to have a channel characteristic that was highest among a plurality of WDs.

Embodiment A3. The network node of Embodiment A2, wherein the channel characteristic includes a least one of a channel strength and a channel direction alignment.

Embodiment A4. The network node of any of Embodiments A2 and A3, wherein determining the least one of a receiver beamformer and a selection of WDs includes determining a channel vector that has a highest a projection onto a subspace formed by channel vectors of the previously determined set of WDs.

Embodiment A5. The network node of any of Embodiments A1-A4, wherein determining the least one of a receiver beamformer and a selection of WDs includes finding an extrema of the objective function based at least in part on a plurality of successive convex approximations (SCAs).

Embodiment A6. The network node of any of Embodiments A1-A5, wherein determining the at least one of the receiver beamformer and the selection of WDs includes alternately determining a selection of WDs that optimizes the objective function for a given receiver beamformer and determining a set of channel vectors that optimizes the objective function for a given set of selected WDs.

Embodiment A7. The network node of any of Embodiments A1-A6, wherein the network node, radio interface and/or processing circuitry are further configured to receive a plurality of local gradients, each local gradient being transmitted from a different one of a plurality of WDs from which the selected WDs are selected.

Embodiment A8. The network node of Embodiment A7, wherein the network node, radio interface and/or processing circuitry are further configured to determine a global loss function based at least in part on the received plurality of local gradients.

Embodiment A9. The method of Embodiment A8, wherein determining the global loss function includes inputting the received plurality of local gradients to a neural network.

Embodiment A10. The method of any of Embodiments A7-A9, wherein the network node, radio interface and/or processing circuitry are further configured to configure each WD to weight a local gradient of the WD by a weight so that a received plurality of weighted local gradients are summed over-the-air.

Embodiment B1. A method implemented in a network node configured to communicate with a wireless device, WD, the method comprising:
determining at least one of a receiver beamformer and a selection of WDs based at least in part on an objective function of a channel vector and a device selection vector.

Embodiment B2. The method of Embodiment B1, wherein determining the least one of a receiver beamformer and a selection of WDs includes successively adding WDs having a channel characteristic that is highest among a plurality of WDs to a set of WDs previously determined to have a channel characteristic that was highest among a plurality of WDs.

Embodiment B3. The method of Embodiment B2, wherein the channel characteristic includes a least one of a channel strength and a channel direction alignment.

Embodiment B4. The method of any of Embodiments B2 and B3, wherein determining the least one of a receiver beamformer and a selection of WDs includes determining a channel vector that has a highest a projection onto a subspace formed by channel vectors of the previously determined set of WDs.

Embodiment B5. The method of any of Embodiments B1-B4, wherein determining the least one of a receiver beamformer and a selection of WDs includes finding an extrema of the objective function based at least in part on a plurality of successive convex approximations (SCAs).

Embodiment B6. The method of any of Embodiments B1-B5, wherein determining the at least one of the receiver beamformer and the selection of WDs includes alternately determining a selection of WDs that optimizes the objective function for a given receiver beamformer and determining a set of channel vectors that optimizes the objective function for a given set of selected WDs.

Embodiment B7. The method of any of Embodiments B1-B6, further comprising receiving a plurality of local gradients, each local gradient being transmitted from a different one of a plurality of WDs from which the selected WDs are selected.

Embodiment B8. The method of Embodiment B7, further comprising determining a global loss function based at least in part on the received plurality of local gradients.

Embodiment B9. The method of Embodiment B8, wherein determining the global loss function includes inputting the received plurality of local gradients to a neural network.

Embodiment B10. The method of any of Embodiments B7-B9, wherein each local gradient of the received plurality of local gradients are weighted at a WD and the received plurality of weighted local gradients are summed over-the-air.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
FL: Federated Learning
NOMA: Non-Orthogonal Multiple Access
OMA: Orthogonal Multiple Access
SCA: Successive Convex Approximation
SNR: Signal to Noise Ratio

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, the network node configured to:
receive an over-the-air aggregation of local gradients, each local gradient being transmitted by a different WD of a set of WDs on a same set of time and frequency resources;
determine a set of transmit scalars based at least in part on an objective function of the aggregation of local gradients, each transmit scalar corresponding to at least one WD of the set of WDs; and
transmit the set of transmit scalars, each transmit scalar of the set of transmit scalars being transmitted to a corresponding WD of the set of WDs.

2. The network node of claim 1, wherein the network node is configured to determine a first WD having a highest value of a channel characteristic among a plurality of WDs and adding the determined first WD to the set of WDs between successive determinations of the set of transmit scalars.

3. The network node of claim 2, wherein the channel characteristic includes one or both of a channel strength and a channel direction.

4. The network node of claim 2, wherein determining the first WD includes selecting a WD having a highest channel vector projection onto a subspace formed by channel vectors of a set of previously selected WDs.

5. The network node of claim 2, wherein the network node is configured to determine a receive beamforming vector and wherein determining the set of transmit scalars is based at least in part on the receive beamforming vector.

6. The network node of claim 5, wherein determining the receive beamforming vector and the set of transmit scalars includes determining a set of selected WDs that optimizes the objective function for a given receiver beamformer.

7. The network node of claim 6, wherein determining the set of selected WDs that optimizes the objective function includes finding an extrema of the objective function based at least in part on a plurality of successive convex approximations (SCAs).

8. The network node of claim 1, wherein determining the set of transmit scalars includes optimizing the objective function for a given set of selected WDs.

9. The network node of claim 8, wherein determining the set of selected WDs is performed for a given receive beamforming vector.

10. The network node of claim 8, wherein determining the set of transmit scalars includes determining the set of selected WDs and determining the receive beamforming vector alternately and iteratively.

11. The network node of claim 1, wherein the network node is configured to minimize the objective function subject to a constraint on a maximum value of a term of the objective function, the maximum value depending at least in part on a number of WDs in the set of WDs.

12. A method implemented in a network node configured to communicate with a wireless device, WD, the method comprising:
receiving an over-the-air aggregation of local gradients, each local gradient being transmitted by a different WD of a set of WDs on a same set of time and frequency resources;
determining a set of transmit scalars based at least in part on an objective function of the aggregation of local gradients, each transmit scalar corresponding to at least one WD of the set of WDs; and
transmitting the set of transmit scalars, each transmit scalar of the set of transmit scalars being transmitted to a corresponding WD of the set of WDs.

13. The method of claim 12, further comprising determining a first WD having a highest value of a channel characteristic among a plurality of WDs and adding the determined first WD to the set of WDs between successive determinations of the set of transmit scalars.

14. The method of claim 13, wherein the channel characteristic includes a one or both of a channel strength and a channel direction.

15. The method of claim 13, wherein determining the first WD includes selecting a WD having a highest channel vector projection onto a subspace formed by channel vectors of a set of previously selected WDs.

16. The method of claim 13, further comprising determining a receive beamforming vector and wherein determining the set of transmit scalars is based at least in part on the receive beamforming vector.

17. The method of claim 12, wherein determining the set of transmit scalars includes determining a set of selected WDs that optimizes the objective function for a given receiver beamformer.

18. The method of claim 17, wherein determining the set of selected WDs that optimizes the objective function includes finding an extrema of the objective function based at least in part on a plurality of successive convex approximations (SCAs).

19. The method of claim 12, wherein determining the set of transmit scalars includes optimizing the objective function for a given set of selected WDs.

20. The method of claim 19, wherein determining the set of selected WDs is performed jointly for a given receive beamforming vector.

21. (canceled)

22. (canceled)
